(19) United States
(12) Patent Application Publication
(10) Pub. No.: US 2015/0103040 A1
(43) Pub. Date: Apr. 16, 2015

(54) TOUCH DEVICE WITH FUNCTION SWITCH CONTROL, SYSTEM WITH THE TOUCH DEVICE, AND METHOD FOR CONTROLLING FUNCTION SWITCH OF THE TOUCH DEVICE

(71) Applicant: ELAN MICROELECTRONICS CORPORATION, Hsin Chu (TW)

(72) Inventors: Jung-Shou HUANG, Zhubei City (TW); Chia-Mu WU, Taipei City (TW)

(73) Assignee: ELAN MICROELECTRONICS CORPORATION

(21) Appl. No.: 14/474,685

(22) Filed: Sep. 2, 2014

(30) Foreign Application Priority Data
Oct. 16, 2013 (TW) 102137270

(51) Int. Cl. G06F 3/044; G06F 3/0354

(52) U.S. Cl. CPC G06F 3/044; G06F 3/03545
USPC 345/174; 345/179

(57) ABSTRACT

A method for controlling function switch of a touch device has steps of reading sensing information on a touch device when an object approaches or contacts the touch device, determining if the sensing information meets a function-switching condition, and if positive, switching the touch device from the first function mode to the second function mode. When executing an application and receiving a switch-on signal from the touch device, a host computer connected to the touch device activates a function to be switched, for example, an eraser function, a webpage button clicking function, a browser zoom function upon drawing in a drawing application.

### BACKGROUND OF THE INVENTION

1. Field of the Invention

The present invention relates to a touch device and a method for controlling the touch device, and more particularly to a touch device with function switch control and a method for controlling function switch of the touch device.

2. Description of the Related Art

Most of current mobile devices, such as smart phones, tablet computers and the like, employ touch screens as operation interfaces for users to input with fingers through the touch screens. Despite a direct and convenient tool for operation, users' fingers may not be appropriate for all operation occasions. Given writing as an example, when a finger slides on a touch screen, such operation occasion may not fit for a great deal of input or fast input because of so much friction involved between the finger and the touch screen. When a finger clicks on an application on the touch screen, misoperation of other applications or functions may arise from a large contact area of the finger. To tackle those problems, styli have been brought to the market. Conventional stylus can be classified into active stylus and passive stylus. The active stylus usually includes a battery and a signal transmission circuit and is therefore more expensive. The passive stylus is advantageous in simple structure and inexpensive cost and utilizes a conductive tip as a contact means between a touch screen and a user. When a capacitive stylus is held and contacted with a touch screen, a capacitive variation appears at a position of the touch screen touched by the stylus for determination of coordinates of the position. However, the passive stylus can only provide two-dimensional (X-axis and Y-axis) information at the absence of third-axis (Z-axis) information. Take drawing for example. Whenever stroke width needs to be varied during the course of drawing, line thickness must be set beforehand. Besides, as the passive stylus does not have battery and signal transmission circuit or button, it is impossible for the passive stylus to further provide more selection signals. Such limitation causes inconvenience when the passive stylus is operated on multi-functional applications.

### SUMMARY OF THE INVENTION

An objective of the present invention is to provide a touch device with function switch control, a touch system with the touch device, and a method controlling function switch of the touch device using the technique of generating sensing information on the touch device when an object approaches or contacts the touch device, and determining to activate function switch when the sensing information meets a function-switching condition.

To achieve the foregoing objective, the touch device has a touch unit and a scan unit.

The touch unit has multiple traces aligned in a first-axis direction and a second-axis direction.

The scan unit is electrically connected to the touch unit, is connected to the traces in the first-axis direction and the second-axis direction to acquire sensing information corresponding to an object on the touch unit, and is built in with a function switch control method. The function switch control method has steps of:

determining if the object on the touch device is a preset object;

determining if the sensing information of the preset object meets a function-switching condition according to a variation of the sensing information of the preset object; and

generating a switch-on signal if the function-switching condition is met.

To achieve the foregoing objective, the touch system has a capacitive stylus, a touch unit and a scan unit.

The capacitive stylus has a main body, a sensing portion and a nib portion.

The sensing portion is mounted on the main body.

The nib portion is retractable and mounted on one end of the main body and has a tip adjusted to vary a distance to the sensing portion.

The touch unit has multiple traces aligned in a first-axis direction and a second-axis direction.

The scan unit is electrically connected to the touch unit, is connected to the traces in the first-axis direction and the second-axis direction to scan sensing information on the touch unit, and is built in with a function switch control method. The function switch control method has steps of:

determining if an object on the touch device is a preset object;

determining if the sensing information meets a function-switching condition according to a sensing information variation of the preset object; and

generating a switch-on signal if the function-switching condition is met.

The touch device is capable of detecting an object with a Z-axis sensing value variation or an area variation. After identifying that the Z-axis sensing value variation reaches a preset threshold or a preset threshold range, the touch device treats it as a signal of function switch. Given a passive capacitive stylus, activation of function switch depends on a Z-axis sensing value or an area varied by adjusting a relative distance between the sensing portion and the touch unit of the touch device. Accordingly, the touch system with a passive capacitive stylus provides not only the Z-axis sensing information but also an additional function-switching capability, which is ideal for multi-functional applications.

Other objectives, advantages and novel features of the invention will become more apparent from the following detailed description when taken in conjunction with the accompanying drawings.

### BRIEF DESCRIPTION OF THE DRAWINGS

FIG. 1A is a schematic view of a touch device with function switch control in accordance with the present invention and in connection with a host computer and a display unit;

FIG. 1B is an operational schematic view of the touch device in FIG. 1A with a capacitive stylus operated thereon;

FIG. 1C is an enlarged side view in partial section of the capacitive stylus in FIG. 1B;

FIG. 2 is a flow diagram of a first embodiment of a method for detecting function switch in accordance with the present invention;

FIGS. 3-1A to 3-1D are operational schematic views of the capacitive stylus operated on different locations on the touch device in FIG. 1B;

FIGS. 3-2A to 3-2D are schematic views of frames on the display unit in FIG. 1A corresponding to operations in FIGS. 3-1A to 3-1D;

FIGS. 3-3A to 3-3D are schematic views of sensing frames corresponding to operations in FIGS. 3-1A to 3-1D;

FIG. 4 is a flow diagram of a second embodiment of a method for detecting function switch in accordance with the present invention; and

FIGS. 5A and 5B are a flow diagram of a third embodiment of a method for detecting function switch in accordance with the present invention.

### DETAILED DESCRIPTION OF THE INVENTION

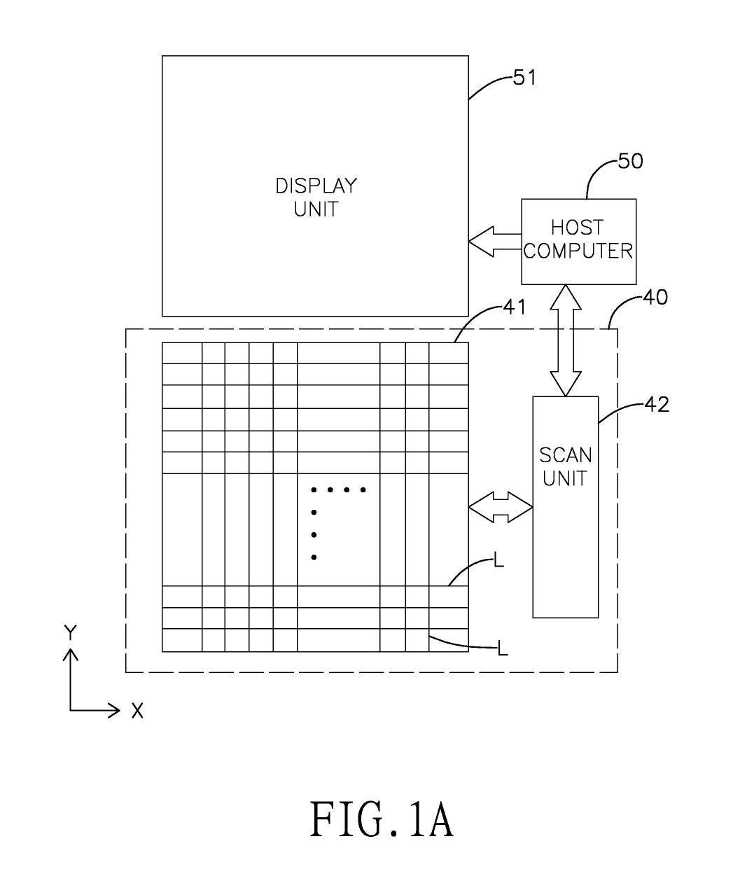

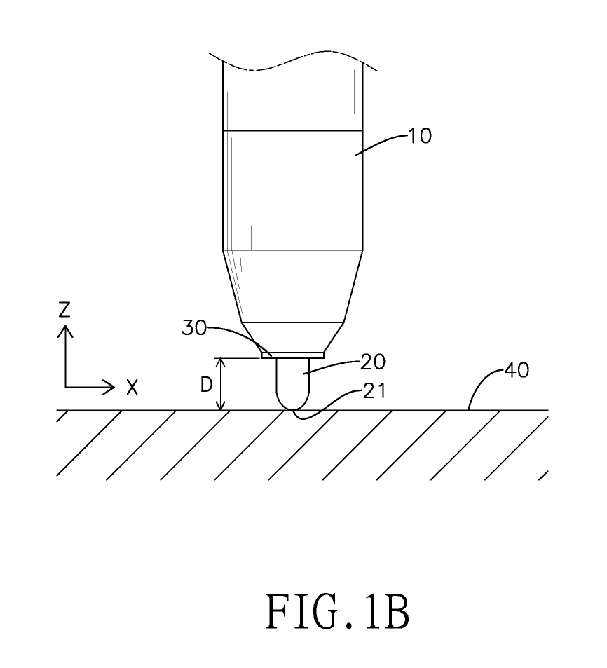

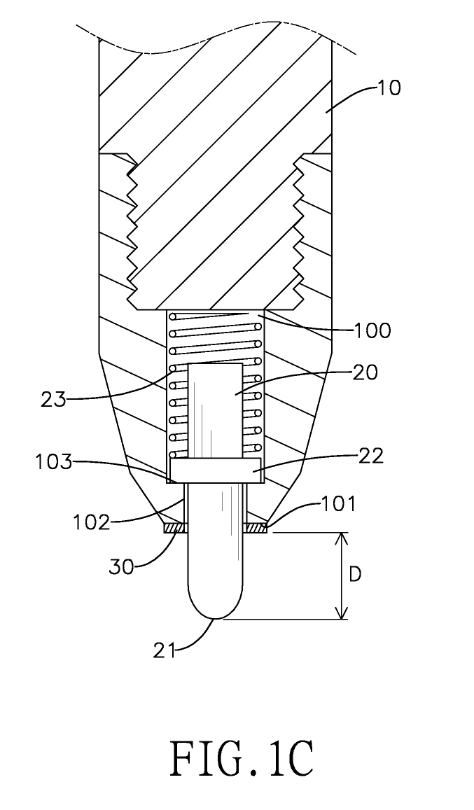

The present invention targets at a control technique taking a movement variation of a touch object along a third axis on a touch device for function switch, such as switch on or off of a button. With reference to FIG. 1A, a touch device 40 with function switch control in accordance with the present invention has a touch unit 41 and a scan unit 42. The scan unit 42 is electrically connected to the touch unit 41, and is connected to multiple traces L aligned in a first-axis direction and a second-axis direction of the touch unit 41 to scan the touch unit 41 for sensing information acquisition. The scan unit 42 is built in with a function switch control method. The function switch control method determines if the touch unit 41 has a preset object thereon; if the preset object is determined to be present, the function switch control method further determines if a function-switching condition is met according to variation of the sensing information of the preset object; if the function-switching condition is met, the function switch control method generates a switch-on signal corresponding to the function-switching condition, and transmits the switch-on signal to a host computer 50 connected to the touch device 40 to switch from a first function mode to a second function mode and achieve a different or corresponding function mode switch, such as switching from a write function to an eraser function. The host computer 50 is electrically connected to a display unit 51. A hand or a capacitive stylus may be used to touch the touch device 40.

With reference to FIGS. 1B and 1C, the touch device 40 in FIG. 1A with a capacitive stylus operated thereon is shown. The capacitive stylus has a main body 10, a nib portion 20 and a sensing portion 30. The main body 10 and the sensing portion 30 may both be metal layers. The nib portion 20 is retractable and mounted on one end of the main body 10. In the present embodiment, the end of the main body 10 with the nib portion 20 mounted thereon is a front end. The main body 10 has a chamber 100, an end portion 101 and a shoulder 103. The chamber 100 is defined inside the front end of the main body 10 for accommodating the nib portion 20. The end portion 101 is formed on the front end of the main body 10, and has a through hole 102 to communicate with the chamber 100. A diameter of the through hole 102 is smaller than an internal diameter of the chamber 100. The shoulder 103 is formed at a junction between the through hole 102 and the chamber 100. The nib portion 20 is slender and has a tip 21 and an annular flange 22. The tip 21 is formed on one end of the nib portion 20 and penetrates through the through hole 102 of the end portion 101 of the main body 10. The annular flange 22 is formed around a periphery of the nib portion 20 inside the chamber 100. An external diameter of the annular flange 22 is greater than the diameter of the through hole 102, and is smaller than the internal diameter of the chamber 100. The annular flange 22 abuts against and is blocked by an inner side of the shoulder 103 to prevent the nib portion 20 from coming off the main body 10. To allow the nib portion 20 to be retractably mounted inside the main body 10, the capacitive stylus further has a resilient element 23, which is mounted inside the chamber 100, and may be a spring mounted around an inner end of the nib portion 20 or a resilient block. Hence, when the main body 10 is pressed down and the tip 21 contacts the touch unit 41, the resilient element 23 is compressed and deformed by a reaction force against the tip 21. When the reaction force is removed or reduced, the resilient element 23 pushes the nib portion 20 to move toward the end portion 101 of the main body 10 with a restoring force. The nib portion 20 may be made of a resilient material. The sensing portion 30 is annularly mounted on the end portion 101 of the main body 10.

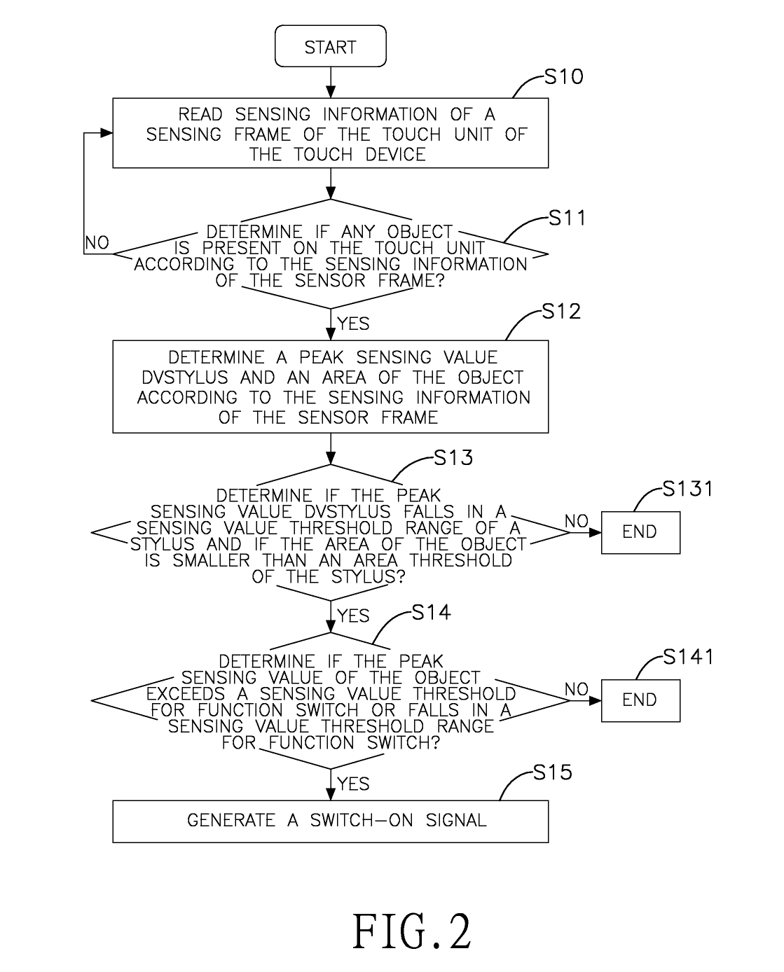

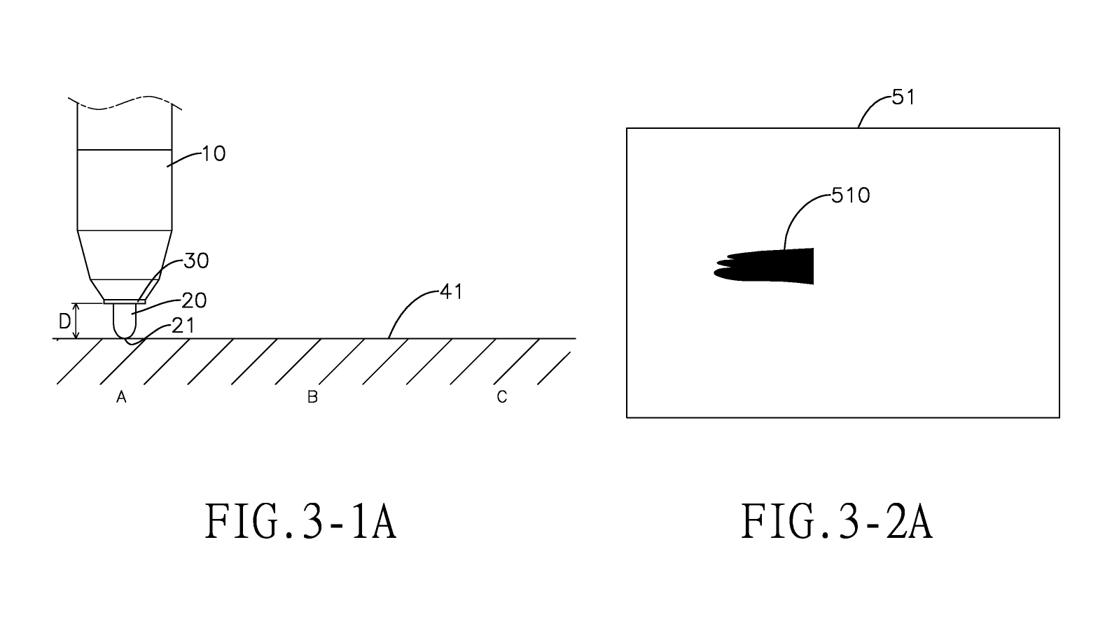

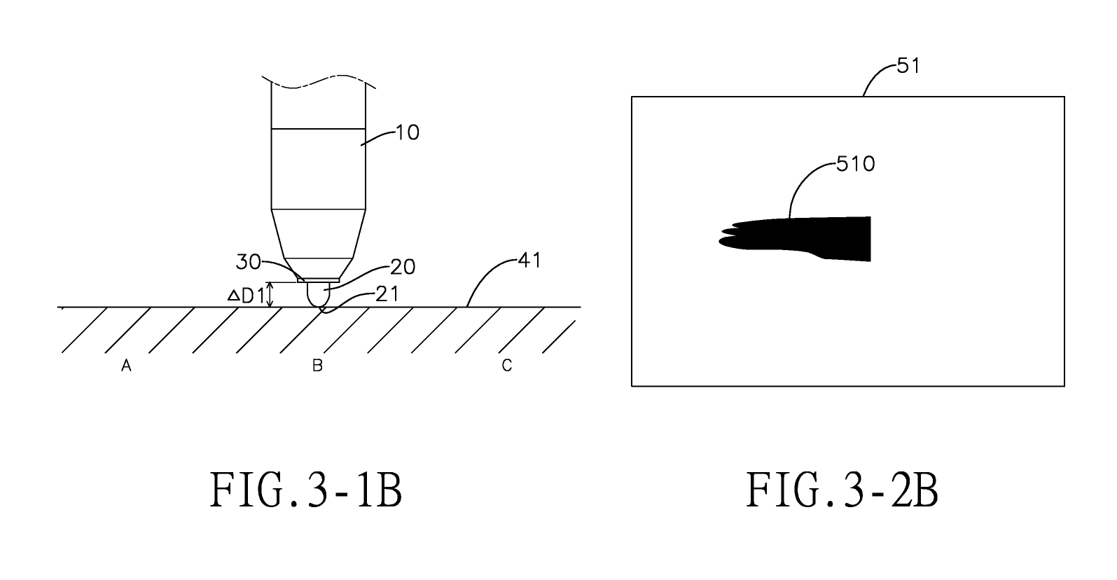

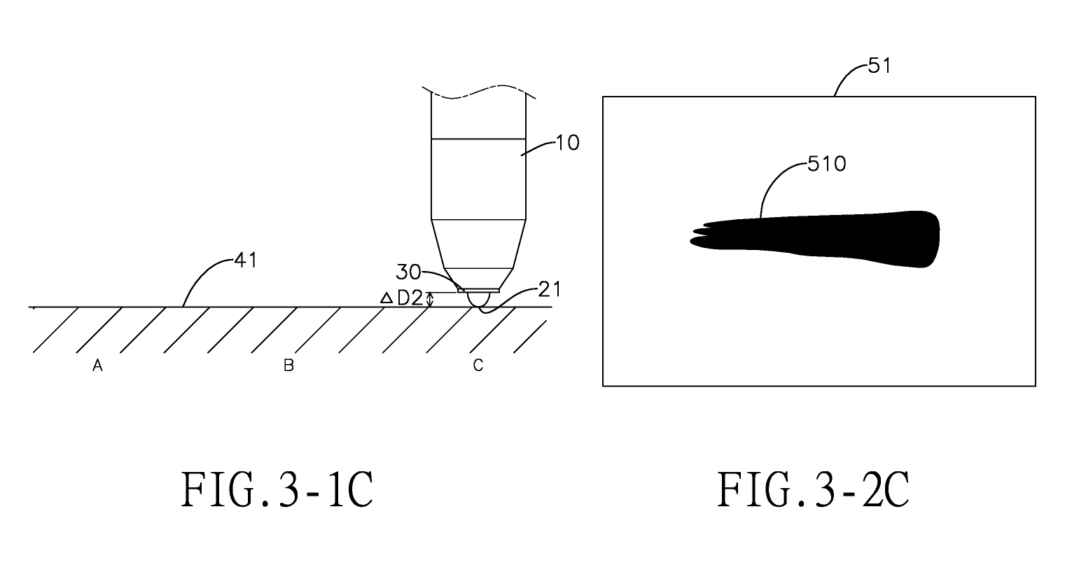

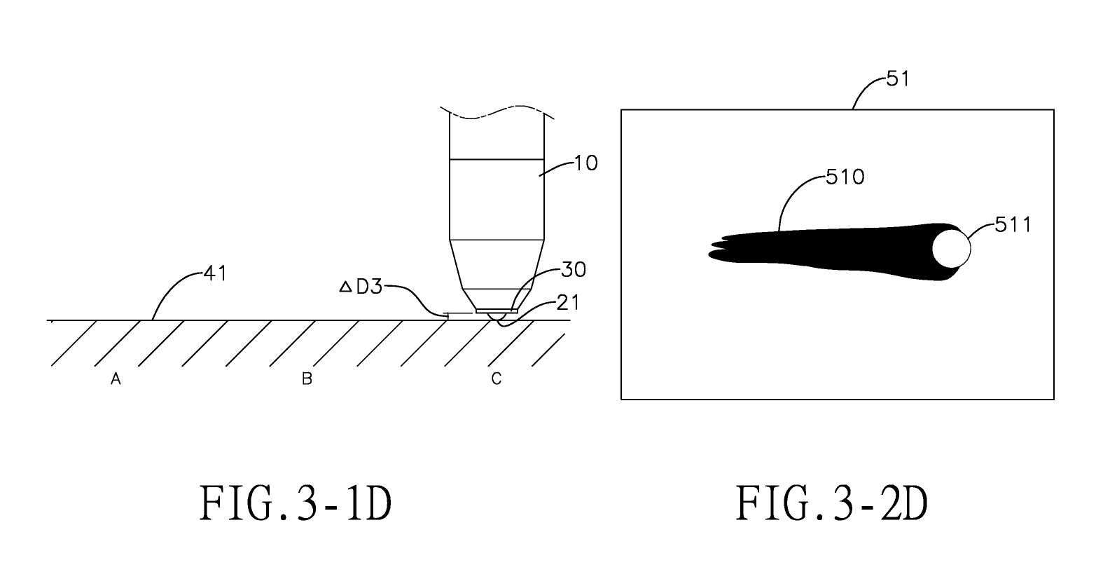

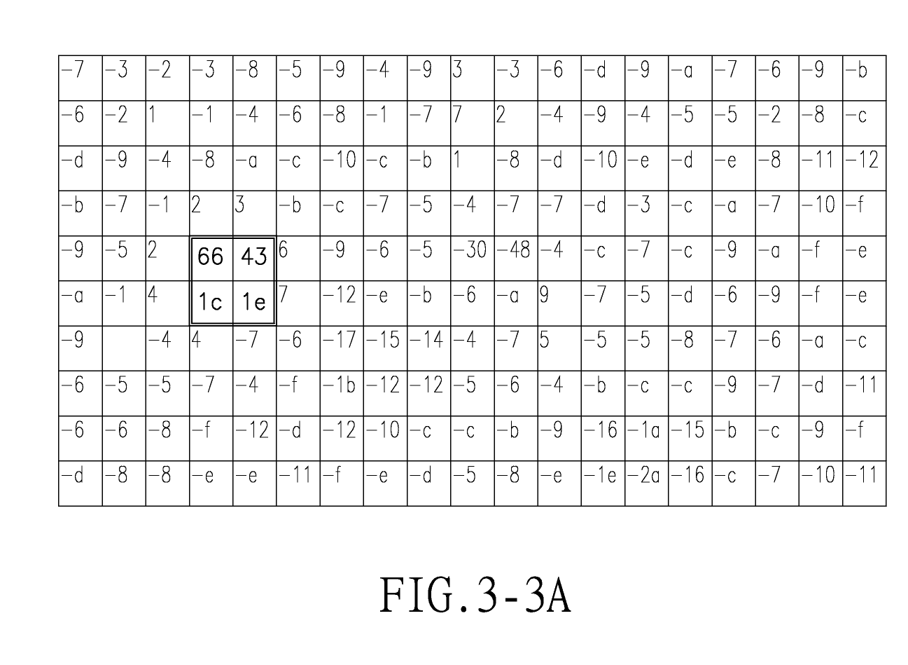

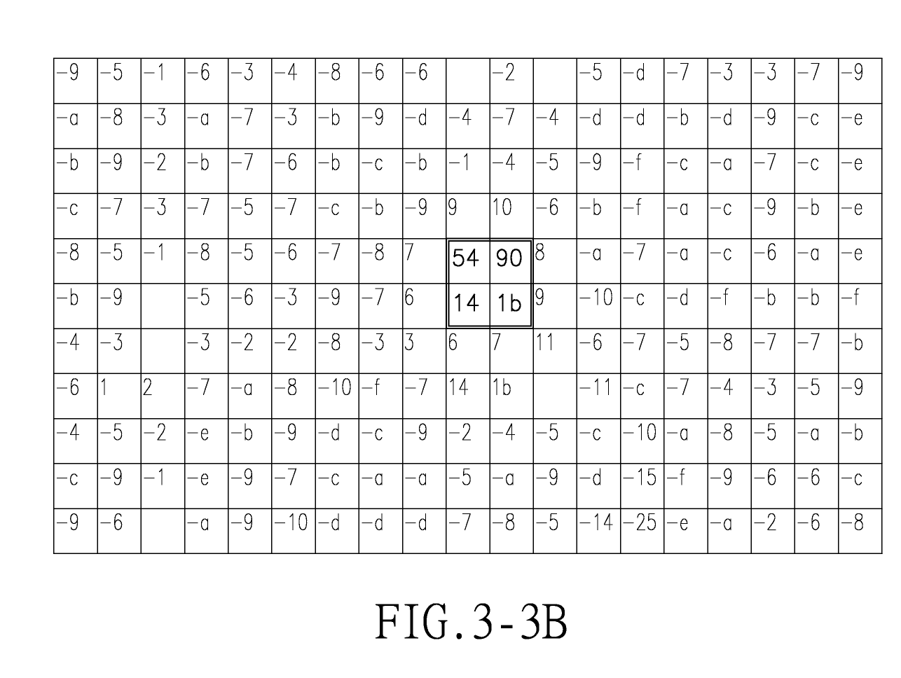

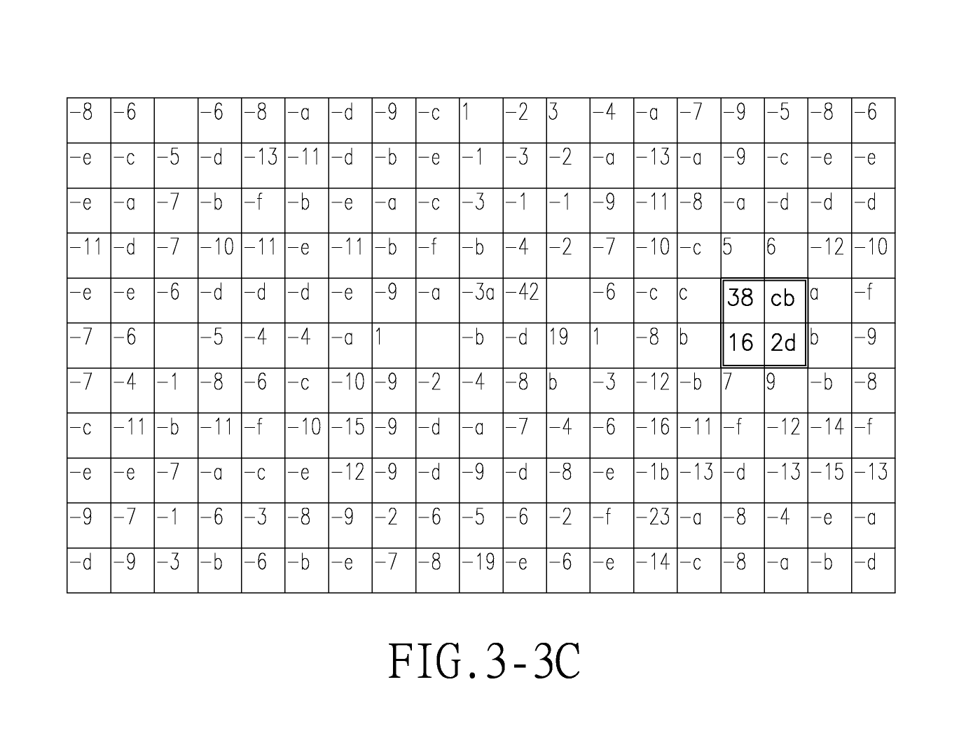

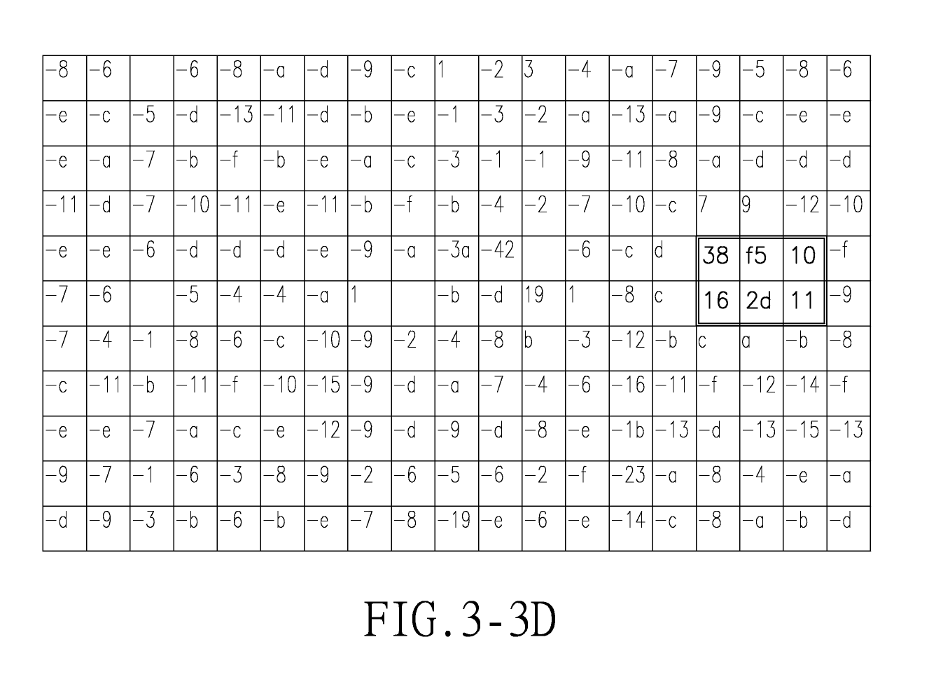

With reference to FIGS. 3-1A to 3-1D, when the stylus is used to slide from a sensing point A to a sensing point C through a sensing point B on the touch unit 41 of the touch device 40 and to exert a pressing force on the touch device 40 progressively increasing from zero at the sensing point A to a maximum at the sensing point C, an initial distance between the sensing portion 30 and the touch device 40 at the sensing point A is D, and after the progressively increasing force is applied, distances between the sensing portion 30 and the touch device 40 at the sensing points B and C are AD1 and AD2 respectively. After the stylus is stopped at the sensing point C, the progressively increasing force further shortens the distance AD2 at the sensing point C to AD3. Accordingly, the distances AD1, AD2 and AD3 are progressively reduced (AD1>AD2>AD3) such that with reference to FIGS. 3-3A to 3-3C, peak sensing values at the three sensing points A, B, C and sensing values of sensing points adjacent to the three sensing points A, B, C progressively increase. As the sensing portion 30 is closer to the touch unit 41 in FIG. 3-1D than in FIG. 3-1C, the peak sensing value at the sensing point C in FIG. 3-3D is higher than the peak sensing values at the sensing points A, B, C in FIGS. 3-3A to 3-3C and a count of the sensing points being adjacent to the sensing point C and having the sensing values exceeding a threshold value also increases in FIG. 3-3D. As a result, the peak sensing values or the count of the sensing points, which are adjacent to the sensing points with the peak sensing values and have the sensing values greater than the threshold value, can be used to reflect a Z-axis sensing value variation of the capacitive stylus. Hence, the touch device 40 can provide the Z-axis sensing value variation to the host computer 50 for a special application. With reference to FIGS. 3-2A to 3-2C, when executing a drawing application, the host computer 50 displays strokes on the display unit 51 corresponding to the sliding paths of the stylus through the sensing points A, B, C on the touch unit 41. As the touch device 40 can further provide the Z-axis sensing value variation of the stylus to the host computer 50, the strokes on the display unit 51 can be adjusted in thickness according to strength of the pressing force that the stylus exerts on the touch unit 41.

The present invention further adds a function switch feature by means of the stylus to provide a method for controlling function switch. Different embodiments are given as follows for description of the method for controlling function switch of the touch device of the present invention.

With reference to FIGS. 1A and 2, a first embodiment of a method for controlling function switch in accordance with the present invention employs the use of the touch device 40 in collaboration with the foregoing capacitive stylus to determine if the stylus is intended for switch function. The method has the following steps.

Step S10: Read sensing information of the touch unit 41 of the touch device 40. The sensing information may be contained in one sensing frame or multiple sensing frames. In the present embodiment, the sensing information of one sensing frame is read.

Step S11: Determine if any object is present on the touch unit 41 according to the sensing information of the sensor frame. If negative, resume the previous step. If positive, execute the next step.

Step S12: Determine a peak sensing value dV_{stylus} and an area of the object according to the sensing information of the sensing frame.

Step S13: Determine if the peak sensing value dV_{stylus} falls in a sensing value threshold range of a stylus and if the area of the object is smaller than an area threshold of the stylus. The area of the object means a count of sensing points corresponding to the object and having the sensing values exceeding a sensing value threshold of the stylus. A lowest bound of the sensing value threshold range of the stylus is a highest noise value limit dVₙₒᵢₛₑ_{_{—}}^{h}_{_{—}}^{bar}, and a highest bound of the sensing value threshold range of the stylus is a lowest finger-sensing value limit dV_{finger}_{_{—}}¹_{_{—}}^{bar} (dVₙₒᵢₛₑ_{_{—}}^{h}_{_{—}}^{bar}<dV_{stylus}<dV_{finger}_{_{—}}¹_{_{—}}^{bar}), thereby lowering noise interference and reducing clicking error done by finger. If the determination result of the current step is positive, it represents that the object on the touch unit 41 arises from a touch of the stylus. If the determination result of the current step is negative, it represents that the object on the touch unit 41 arises from a low-sensitivity noise or a high-sensitivity object, such as a finger, and a process of the method is terminated (S131).

Step S14: Determine if the peak sensing value of the object exceeds a sensing value threshold for function switch dV_{stylus}_{_{—}}^{TH} or falls in a sensing value threshold range for function switch dV_{stylus}_{_{—}}^{THL}˜dV_{stylus}_{_{—}}^{THH}. If positive, it represents that a function switch is performed. If negative, the process of the method is terminated (S141). The sensing value threshold for function switch and the sensing value threshold range for function switch are different function-switching conditions of the present invention. The sensing value threshold for function switch is greater than the sensing value threshold of the stylus and the lowest finger-sensing value of the limit sensing value threshold range of the stylus. In the present embodiment, the peak sensing values of the object in the steps S13 and S14 are both read from the sensing information of an identical sensing frame.

Step S15: Generate a switch-on signal. The scan unit 42 of the touch device 40 transmits the switch-on signal to the host computer 50 connected to the scan unit 42 to perform a corresponding function-switching operation and switch from a first function mode to a second function mode.

With further reference to FIGS. 1A, 3-1D to 3-3D, supposed that the stylus has been pressed down for the sensing portion 30 thereof to be closer to the touch unit 41 and the peak sensing value sensed by the touch device 40 is the highest, the conditions in the steps S13 and S14 can therefore be met. The touch device 40 instructs the scan unit 42 to generate the switch-on signal and send the switch-on signal to the host computer 50. Meanwhile, if the host computer 50 is executing a drawing application, the drawing application has already entered a stylus mode because the sensing frame in FIG. 3-3A contains a stylus thereon. With reference to FIGS. 3-2A to 3-2C, the host computer 50 then displays strokes 510 varying in thickness on the display unit 51. If the stylus is further pressed down as shown in FIG. 3-2D, the peak sensing value of the stylus exceeds the sensing value threshold for function switch, and the condition in the step S13 in FIG. 2 is met. The host computer 50 then receives the switch-on signal to switch the line-drawing function to an eraser function 511 so as to provide more convenient drawing capability.

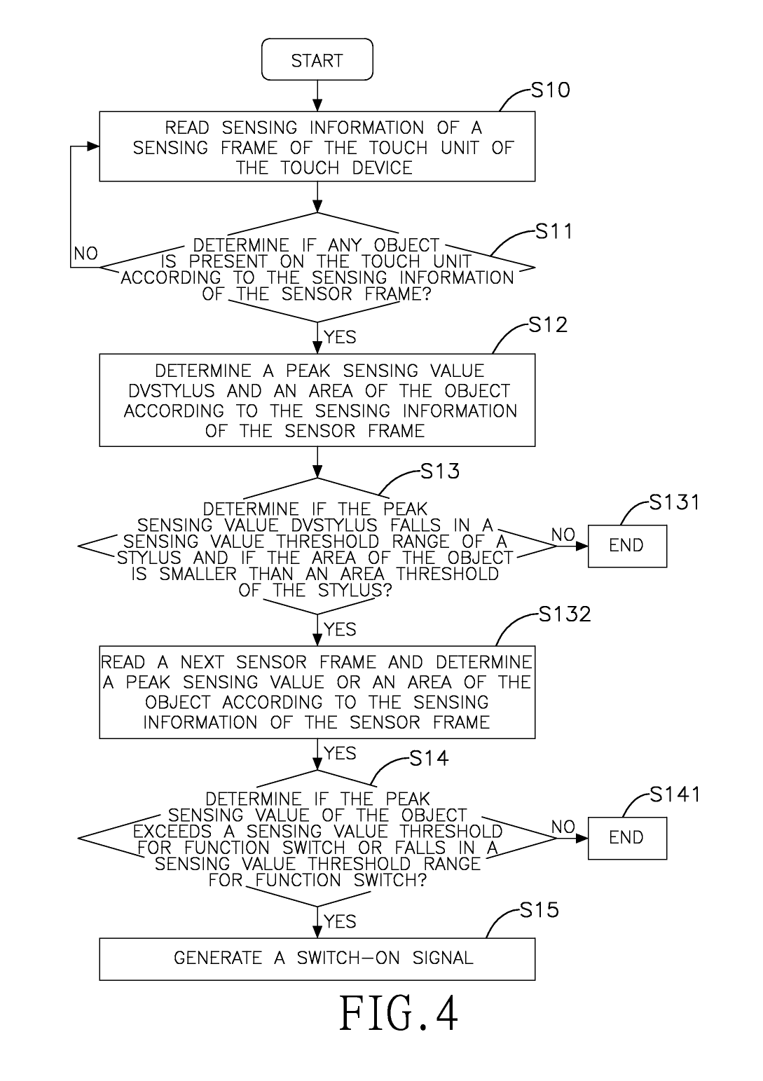

With reference to FIG. 4, a second embodiment of a method for controlling function switch in accordance with the present invention differs from the first embodiment in further providing a step S132 as follows between the steps S13 and S14.

Step S 132: Read a next sensing frame and determine a peak sensing value dV_{stylus} or an area of the object according to the sensing information of the sensing frame.

The present embodiment takes reading sensing information of multiple sensing frames into account. In other words, the step S11 determines if there is any object present on any one of multiple sensing frames sequentially read in the step S10, and if positive, after the steps S12 and S13 are performed to confirm that the object is a stylus, the sensing frame with the object and the next sensor frame read in the step S132 are provided for the step S14 to determine if the sensing value variations of the two sensing frames exceed the sensing value threshold for function switch or fall in a sensing value threshold range for function switch.

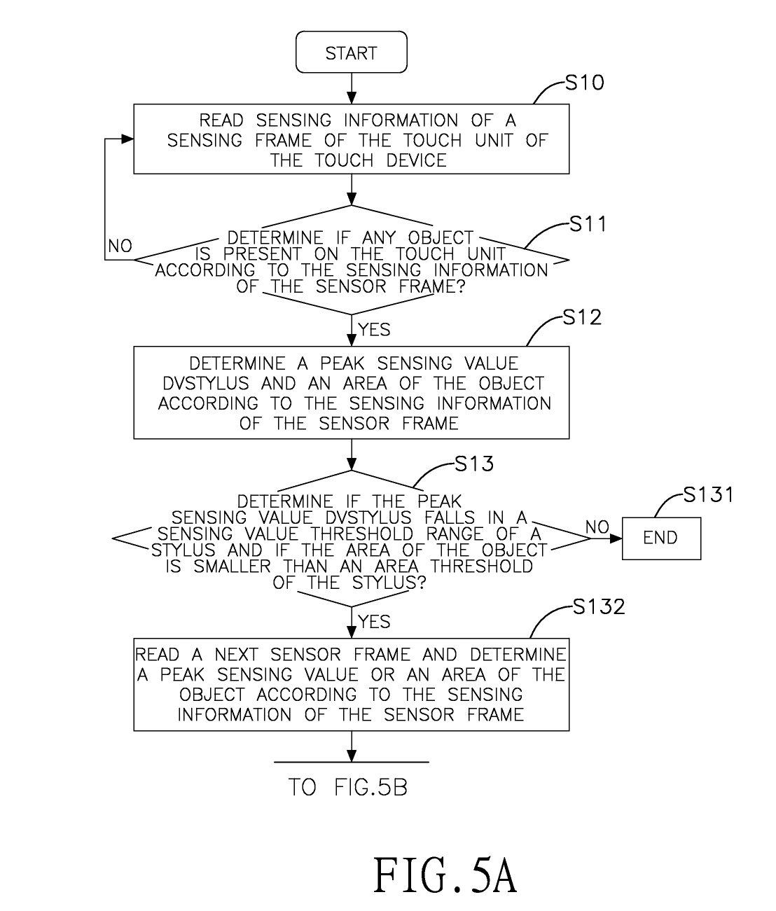

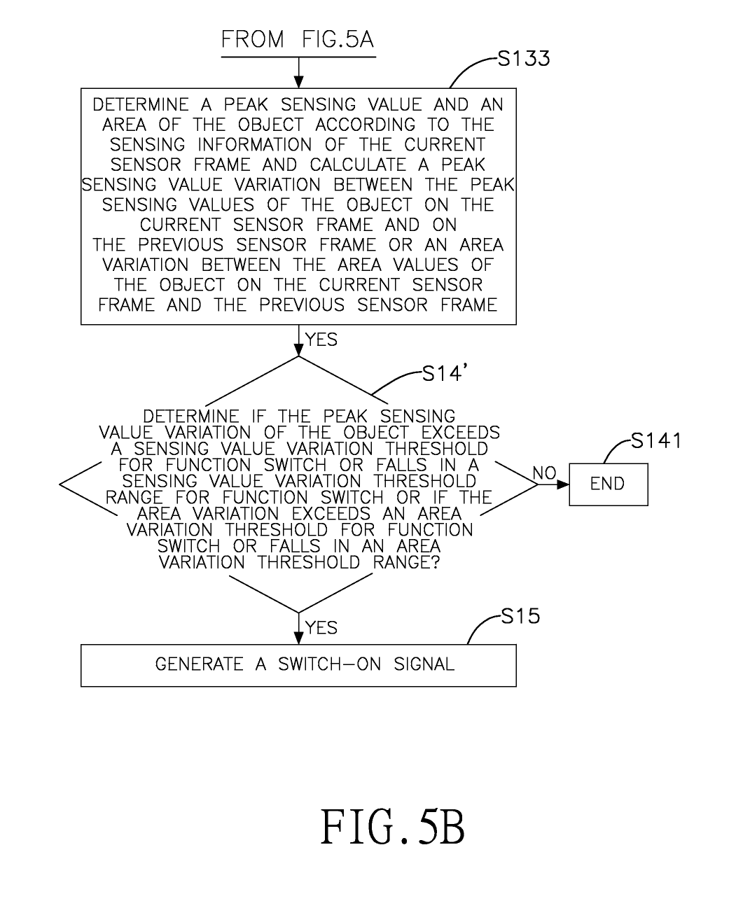

With reference to FIGS. 5A and 5B, a third embodiment of a method for controlling function switch in accordance with the present invention differs from the second embodiment in further providing a step S133 as follows between the step S132 and S14 and a modified step S14′ replacing the step S14 in the second embodiment.

Step S132: Determine a peak sensing value and an area of the object according to the sensing information of the current sensing frame.

Step 133: Calculate a peak sensing value variation between the peak sensing values of the object on the current sensing frame and on the previous sensing frame or an area variation between the area values of the object on the current sensing frame and the previous sensing frame.

The present embodiment also takes reading sensing information of multiple sensor frames into account. The step S11 determines if there is any object present on any one of multiple sensing frames sequentially read in the step S10. If positive, after the step S13, the peak sensing value or the area of the next sensing frame is determined in the step S132 for the step S133 to calculate the peak sensing value variation or the area variation between the object on the current sensing frame and the object on the previous sensing frame. The step S14′ further determines if the peak sensing value variation of the object exceeds a sensing value variation threshold for function switch or falls in a sensing value variation threshold range for function switch or if the area variation exceeds an area variation threshold for function switch or falls in an area variation threshold range.

In sum, the touch device of the present invention can identify Z-axis sensing value or an area variation of an object thereon to further determine if the switch-on signal is generated such that the host computer 50 can add a special function for receiving the switch-on signal corresponding to a specific application, such as an eraser function, a webpage button clicking function, a browser zoom function or the like upon drawing in a drawing application.

Additionally, the touch device in collaboration with a capacitive stylus constitutes a touch system. To allow the nib portion of the capacitive stylus to be collapsibly mounted on the main body, besides the resilient element added in FIG. 1C, the nib portion may be made of a resilient material.

The passive capacitive stylus is taken as an example of the object in the foregoing embodiments. However, the foregoing object includes, but is not limited to, the passive capacitive stylus. As far as an active capacitive stylus is concerned, besides necessary circuits, a sensing portion is further required and a collapsible nib portion is mounted on one end of the main body of the stylus. Supposing that a distance of the tip relative to the sensing portion mounted on the main body of the stylus is changeable, the active capacitive stylus can be also taken as an object to be applied to the touch device or touch system in the foregoing embodiments.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for controlling function switch of a touch device, comprising steps of:
reading sensing information of an object on a touch device, wherein the sensing information is generated when the object approaches or contacts the touch device;
determining if the sensing information meets a function-switching condition for switching the touch device from a first function mode to a second function mode; and
switching the touch device from the first function mode to the second function mode if the function-switching condition is met.

2. The method as claimed in claim 1, wherein
the sensing information has at least one sensing value of the object;
the function-switching condition includes a sensing value threshold for function switch or a sensing value threshold range for function switch; and
the step of determining if the sensing information meets the function-switching condition further has a step of determining if the at least one sensing value of the object exceeds the sensing value threshold for function switch or falls in the sensing value threshold range for function switch, wherein the function-switching condition is met when a determination result is positive.

3. The method as claimed in claim 1, wherein
the sensing information is a sensing value variation of the object;
the function-switching condition includes a sensing value variation threshold for function switch or a sensing value variation threshold range for function switch; and
the step of determining if the sensing information meets the function-switching condition further has a step of determining if the sensing value variation of the object exceeds the sensing value variation threshold for function switch or falls in the sensing value variation threshold range for function switch, wherein the function-switching condition is met when a determination result is positive.

4. The method as claimed in claim 1, wherein
the sensing information is an area variation of the object;
the function-switching condition includes an area variation threshold for function switch or an area variation threshold range for function switch; and
the step of determining if the sensing information meets the function-switching condition further has a step of determining if the area variation of the object exceeds the area variation threshold for function switch or falls in the area variation threshold range for function switch, wherein the function-switching condition is met when a determination result is positive.

5. The method as claimed in any one of claims 1, wherein
the sensing information of the object is generated by a stylus when the stylus approaches or contacts the touch device;
the method further comprises a stylus identification step having steps of:
determining at least one sensing value of the sensing information and an area of the object according to the sensing information; and
determining that the object is the stylus when the at least one sensing value of the object falls in a sensing value threshold range of the stylus and the area of the object is smaller than an area threshold of the stylus.

6. The method as claimed in claim 5, wherein the area of the object is a count of at least one sensing point corresponding to the object and each one of the at least one sensing point has a corresponding sensing value exceeding a sensing value threshold of the stylus.

7. The method as claimed in claim 6, wherein the stylus identification step is performed before the step of determining if the sensing information meets the function-switching condition.

8. The method as claimed in claim 7, wherein a lowest bound of the sensing value threshold range of the stylus is a highest noise value limit, and a highest bound of the sensing value threshold range of the stylus is a lowest finger-sensing value limit.

9. The method as claimed in claim 6, wherein the step of reading sensing information of an object on a touch device has a step of sequentially reading multiple sensing frames of the touch device, and the stylus identification step and the step of determining if the sensing information meets a function-switching condition are performed according to the sensing information of an identical sensing frame.

10. The method as claimed in claim 2, wherein
the sensing information of the object is generated by a stylus when the stylus approaches or contacts the touch device;
the method further comprises a stylus identification step having steps of:
determining the at least one sensing value of the sensing information and an area of the object according to the sensing information; and
determining that the object is the stylus when the at least one sensing value of the object falls in a sensing value threshold range of the stylus and the area of the object is smaller than an area threshold of the stylus.

11. The method as claimed in claim 10, wherein the area of the object is a count of at least one sensing point corresponding to the object and having the corresponding sensing value exceeding a sensing value threshold of the stylus.

12. The method as claimed in claim 11, wherein the stylus identification step is performed before the step of determining if the sensing information meets the function-switching condition.

13. The method as claimed in claim 12, wherein a lowest bound of the sensing value threshold range of the stylus is a highest noise value limit, and a highest bound of the sensing value threshold range of the stylus is a lowest finger-sensing value limit.

14. The method as claimed in claim 13, wherein the sensing value threshold for function switch is greater than the sensing value threshold of the stylus and the lowest finger-sensing value limit of the sensing value threshold range of the stylus.

15. The method as claimed in claim 10, wherein the step of reading sensing information of an object on a touch device has a step of sequentially reading multiple sensing frames of the touch device, and the stylus identification step sequentially determines the multiple sensing frames, and after determines that one of the sensing frames has the object present thereon, compares a next sensing frame and the sensing frame with the object thereon and determines if the function-switching condition is met.

16. A touch device with function switch control, comprising:
a touch unit having multiple traces aligned in a first-axis direction and a second-axis direction;
a scan unit electrically connected to the touch unit, connected to the traces in the first-axis direction and the second-axis direction to acquire sensing information corresponding to an object on the touch unit, and built in with a function switch control method, wherein the function switch control method has steps of:
determining if the object on the touch device is a preset object;
determining if the sensing information of the preset object meets a function-switching condition according to a variation of the sensing information of the preset object; and
generating a switch-on signal if the function-switching condition is met.

17. The touch device as claimed in claim 16, wherein
the sensing information has at least one sensing value of the preset object;
the function-switching condition includes a sensing value threshold for function switch or a sensing value threshold range for function switch; and
the step of determining if the sensing information meets the function-switching condition further has a step of determining if the at least one sensing value of the preset object exceeds the sensing value threshold for function switch or falls in the sensing value threshold range for function switch, wherein the function-switching condition is met when the determination result is positive.

18. The touch device as claimed in claim 16, wherein
the sensing information is a sensing value variation of the object;
the function-switching condition includes a sensing value variation threshold for function switch or a sensing value variation threshold range for function switch; and
the step of determining if the sensing information meets the function-switching condition further has a step of determining if the sensing value variation of the preset object exceeds the sensing value variation threshold for function switch or falls in the sensing value variation threshold range for function switch, wherein the function-switching condition is met when a determination result is positive.

19. The touch device as claimed in claim 16, wherein
the sensing information is an area variation of the object;
the function-switching condition includes an area variation threshold for function switch or an area variation threshold range for function switch; and
the step of determining if the sensing information meets the function-switching condition further has a step of determining if the area variation of the object exceeds the area variation threshold for function switch or falls in the area variation threshold range for function switch, wherein the function-switching condition is met when a determination result is positive.

20. A touch system with function switch control, comprising:
a capacitive stylus having:
a main body;
a sensing portion mounted on the main body; and
a nib portion being retractable and mounted on one end of the main body and having a tip adjusted to vary a distance to the sensing portion; and
a touch unit having multiple traces aligned in a first-axis direction and a second-axis direction;
a scan unit electrically connected to the touch unit, connected to the traces in the first-axis direction and the second-axis direction to scan sensing information on the touch unit, and built in with a function switch control method, wherein the function switch control method has steps of:
determining if an object on the touch device is a preset object;
determining if the sensing information meets a function-switching condition according to a sensing information variation of the preset object; and
generating a switch-on signal if the function-switching condition is met.

21. The touch system as claimed in claim 20, wherein the main body has:
a front end; and
a chamber defined inside the front end of the main body for accommodating the nib portion.

22. The touch system as claimed in claim 21, wherein
the main body further has:
an end portion formed on the front end of the main body, and has a through hole communicating with the chamber and penetrated through by the tip; and
a shoulder formed at a junction between the through hole and the chamber; and
the nib portion further has an annular flange formed around a periphery of the nib portion inside the chamber with an external diameter of the annular flange greater than a diameter of the through hole and smaller than an internal diameter of the chamber, and abutting against and blocked by an inner side of the shoulder.

23. The touch system as claimed in claim 22, wherein the capacitive stylus further has a resilient element mounted inside the chamber of the main body and is mounted between an inner wall of the chamber and an inner end of the nib portion.

24. The touch system as claimed in claim 22, wherein the nib portion is made of a resilient material.

25. The touch system as claimed in any one of claims 21, wherein the sensing portion is partially mounted around a periphery of the main body.

26. The touch system as claimed in claim 21, wherein the sensing portion is located on the front end of the main body.

27. The touch system as claimed in claim 26, wherein the sensing portion is an annular metal layer.
